(19) United States
(12) Patent Application Publication
(10) Pub. No.: US 2011/0307293 A1
(43) Pub. Date: Dec. 15, 2011

(54) Method For Assessing And Communicating Organizational Human Error Risk And Its Causes

(76) Inventor: J. Martin Smith, Burlington (CA)

(21) Appl. No.: 13/051,458

(22) Filed: Mar. 18, 2011

Related U.S. Application Data
(63) Continuation of application No. 12/599,810, now abandoned.

(30) Foreign Application Priority Data
May 11, 2007 (CA) 2588347

(51) Int. Cl. G06Q 10/00

(52) U.S. Cl. 705/7.28

(57) ABSTRACT

A method of preventing human error in an organization, the method comprising: making a plurality of collections of pychosocial awareness factor data over an error prediction time period from individuals performing tasks within the organization; accessing human error data relating to the error prediction time period on human error incidents within the organization; using the human error data and psychosocial awareness factor data to determine whether the level of one or more awareness factors predicts human error; if said one or more awareness factors predicts human error, notifying the organization of the nature of the human error predicted, and of the one or more awareness factors that are the cause of the human error.

### FIELD OF THE INVENTION

This invention relates to the field of industrial psychology, and in particular, the field of human error.

### BACKGROUND OF THE INVENTION

Human error is a source of heavy economic costs, injury and death in many different fields, and there are certain fields in which human error can have particularly catastrophic results. Examples include aviation, medicine, pharmacology, nuclear energy, transportation, emergency response services (police, fire, ambulance), military, security services, manufacturing, and supply distribution.

For example, the failure of an operator in a nuclear power plant to notice a dangerous condition could lead to many deaths and injuries, and enormous economic damage. A passenger jet pilot failing to properly appreciate the local weather conditions as he takes off or lands could result in the jet crashing, a catastrophic outcome.

Even non-catastrophic human error can have very significant harmful economic consequences. For example, if baggage handlers working at an airport often crash the baggage/cargo carts, thus damaging equipment, cargo and baggage, the economic consequences for the cargo owner, and the airline, will be substantial. While it is rare for this type of human error to have catastrophic results, there is still a substantial economic benefit associated with identifying and reducing the risk of this type of human error.

Typically, industries in which human error can be catastrophic are regulated, and these regulations typically require that each organization have a dedicated safety officer, who reports directly to the chief executive officer of the organization. The reason for this requirement is that, in the past, persons aware of safety risks have attempted to communicate those risks through the organization's bureaucracy, but the warnings did not reach persons capable of initiating action in time to prevent a catastrophe. By having a dedicated safety officer with a direct link to the chief executive officer, persons with concerns about safety can communicate with the safety officer, who in turn will communicate directly with the CEO who has the power to take action to prevent catastrophe.

The most commonly used method for prospective reduction of error risk is Failure Mode and Effects Analysis (FMEA). FMEA is used to select remedial actions that reduce the risk of errors, as well as the impact of the consequences of those errors. The three basic parameters in FMEA are (1) severity (S); (2) likelihood of occurrence (O), or probability (P); and (3) inability of controls to detect the error (D). In FMEA, the overall risk of each failure is called the Risk Priority Number (RPN), and the RPN is the product of S, O and D. The RPN is used to prioritize all potential failures and to decide upon actions that reduce the risk of the failure, usually by reducing likelihood of occurrence and improving controls for detecting the failure.

The main problem with FMEA, particularly in respect of human error, is that FMEA does not attempt to determine the causes of errors. Rather, FMEA is focused exclusively on error rates and severity of consequences. Thus, an organization may be aware of what types of errors happen most often, and cause the most severe damage, but using only FMEA gives little guidance on what steps to take to prevent the errors from happening. The result may be that the organization takes action to prevent error, but the action is unrelated to the actual cause, and is therefore ineffective.

### SUMMARY OF THE INVENTION

Therefore, what is required is a method of preventing human error in an organization, which method is able not only to predict error, but to identify the cause of the error to permit effective action to remove the risk before the error occurs. According to the present invention, there is provided a method of preventing human error in an organization, the method comprising:

making a plurality of collections of psychosocial awareness factor data over an error prediction time period from individuals performing tasks within the organization;

accessing human error data relating to the error prediction time period on human error incidents within the organization;

using the human error data and psychosocial awareness factor data to determine whether the level of one or more awareness factors predicts human error;

if said one or more awareness factors predicts human error, notifying the organization of the nature of the human error predicted, and of the one or more awareness factors that are the cause of the human error.

### BRIEF DESCRIPTION OF THE DRAWINGS

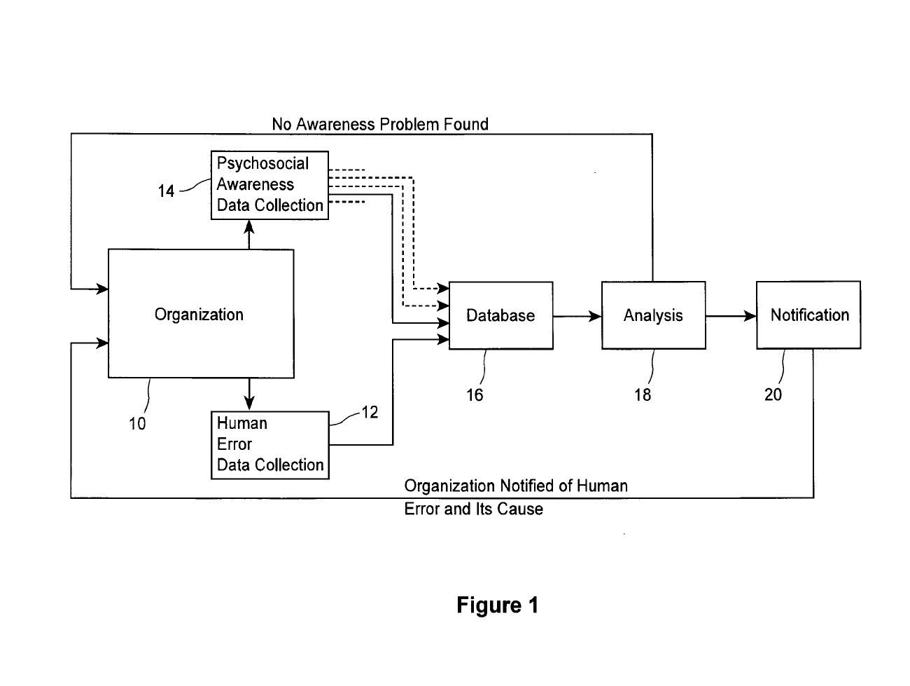

The invention will now be illustrated, by way of example only, in the attached drawing, which shows the preferred embodiment of the invention, and in which FIG. 1 is a schematic drawing showing a preferred form of the method of the present invention.

### DETAILED DESCRIPTION OF THE PREFERRED EMBODIMENTS

Scientific research has found that the risk of human error is a function of nine types of human awareness, otherwise known as psychosocial constructs or awareness factors. Using these nine psychosocial constructs, it is possible to determine not only whether there is an elevated risk of human error; it is also possible to determine, with greater specificity than that available from FMEA, the cause of such elevated risk of human error.

The nine psychosocial constructs associated with human error are:
(1) Anticipatory Awareness—awareness that imagines and anticipates possible scenarios. Such awareness includes, for example, the forecasting of potential situational variables and their movement, and the ability to imagine multiple scenarios while interpreting the implications and consequences of each.
(2) Task-Empirical Awareness—awareness of how to assess for the “normal” operation of the task at hand. This type of awareness involves, for example, the individual understanding the normal operational limits of the task for him, and taking steps to maintain himself within those normal operational limits.
(3) Affective Awareness—awareness of how one's emotions, feelings and/or sensory experience informs safe operation. This involves, for example, both awareness of one's own emotional state, and knowing that shifts in the feeling or emoting experience of an individual signal a situational change which may require adaptation.
(4) Compensatory Awareness—awareness that causes the individual to adjust or compensate for situational variables. This type of awareness is the product of flexibility and accommodation within the individual in order to maintain safe operation given specific situational dynamics. Thus, for example, this type of awareness would cause the subject to knowingly modify their behaviour in response to operational distractions such as, for example, disruptive behaviour, loud external noises or catastrophic events. An individual having this type of awareness typically makes an immediate adjustment in thinking and behaviour to accommodate for situational conditions that the individual has read and interpreted.
(5) Critical Awareness—awareness that causes and individual to assess and evaluate the task at hand against his own bank of experience. So, for example, an individual with high Critical Awareness would likely have a clear understanding of the risks associated with working while sleep-deprived or medicated. Such an individual also knows, from experience, what operational pace is appropriate to ensure safety. Similarly, other aspects of his experience are used by the individual to assess and evaluate the present task at hand.
(6) Relational Awareness—awareness for how the “other” influences safe operations. This type of awareness can have a number of different aspects. Thus, for example, if a particular individual feels that his concerns about safety are less important than other people's concerns, then he may lack Relational Awareness. An understanding of the value of team cohesion in operational success and in safety is an aspect of Relational Awareness. Similarly, Relational Awareness would typically include clearly understanding the roles played by each individual in the completion of the task.
(7) Functional Awareness—awareness for the meaning or function of objects of the individual's experience. Thus, being aware of why the individual would don a mask during air plane depressurization is example of Functional Awareness.
(8) Environmental Awareness—awareness of how variables in this physical and cultural environment impact safety. This awareness covers both how physical objects affect safety (e.g. improper positioning of the seat in a vehicle) and how cultural factors do so (e.g. support from management for the raising of safety issues by employees).
(9) Hierarchical Awareness—awareness of an object's place, order or hierarchy or importance in a sequence. For example, in a transportation-related context, this type of awareness would involve knowing the implications of specific weather conditions, road surfaces and traffic patterns according to their order of importance.

Referring now to FIG. 1, according to the present invention, risk of human error in an organization 10 is determined by making a plurality of collections of psychosocial awareness (reference numeral 14) factor data over an error prediction time period from members of organization 10. This data is preferably held in a database 16, providing the resources for storage and analysis of the data. In the preferred embodiment, members of the organization 10 will be asked a selection of questions at least four times per year, though it will be appreciated that higher or lower frequencies are possible, depending on the circumstances. The questions are selected to determine the levels of the awareness factors described above. Also, because each member answers such questions periodically over time, the changes in the awareness factors among the organization members over time can be tracked.

It will be appreciated that, to exhaustively probe the level of any particular type of awareness, it is preferable to ask a wide variety of questions whose answers provide information on various aspects of the particular kind of awareness. So, for example, regarding Anticipatory Awareness, two example questions that may be asked are whether early signs of an operational challenge are always evident to the individual, and whether the individual can see how here-and-now events will unfold in the near future. These two questions are directed to different aspects of Anticipatory Awareness. Preferably, an inventory of questions is available that exhaustively covers the various aspects of each psychosocial construct. (The preferred inventory is reproduced in an appendix at the conclusion of this detailed description.) Furthermore, preferably, each individual answers a subset of the inventory each time data is collected from him, so that after a pre-selected number of data collections (e.g. four per year), he has answered the entire inventory of questions.

It will be appreciated that, preferably, questions from the inventory are not asked of each organization member in the same order. Most preferably, after the first data collection, each of the questions of the inventory will have been asked of at least one organization member. This approach is preferable, because data on every aspect of each type of awareness becomes immediately available on all aspects of each psychosocial construct, and it may be possible, depending on the sample size and other statistical parameters, to be able to draw valid conclusions from the data even though each member has not yet answered all, or even most, of the questions in the inventory.

Preferably, organization members will answer questions confidentially or anonymously, using an internet-based questionnaire provided to them. It will be appreciated that the questions relating to psychosocial constructs often demand an answer that could make an individual fear discipline or dismissal. An individual may also have an incentive to answer the question dishonestly to make himself look better than he actually is, hoping that the organization see his answer and think more highly of him. For example, in relation to Affective Awareness, an individual may be asked whether he tends to deny the negative effects of exhaustion on his performance. An individual facing such a question may legitimately fear negative consequences from answering in the affirmative. As another example, in relation to Anticipatory Awareness, an individual may be asked to agree or disagree with the statement, “I will not ignore the performance shortcomings of my peers and coworkers.” The individual may be tempted to agree with this statement even if the answer is false, hoping that his employers will see him as an exceptional employee with leadership potential. Thus, the shielding of the identity of the employee is helpful for encouraging honest responses. It is preferred that individuals know that their answers will not have any impact on their individual employment, whether positive or negative.

It will be appreciated that tracking of levels of the various psychosocial constructs over time will provide useful information in a number of ways. First, simply having data about the levels of the various types of awareness at a single point in time provides useful information, as such data may show that one or more types of awareness are at dangerously low levels, pointing to the risk of particular kinds of human error, and indicating what the cause of the error will be.

Thus, for example, it may become apparent, after only the first collection of data when no time has yet passed, that there is a dangerously low level of Anticipatory Awareness among the members of the organization. Specifically, the data may show that members of the organization are unusually lacking in anticipation of possible scenarios during the performance of their tasks. It may further be apparent from the answers given to the initial set of questions that the reason for low Anticipatory Awareness is a cultural one; members of the organization, for example, may rarely be asked by their superiors for feedback on possible situations that may arise, and may not be encouraged to consider this issue. Thus, a recommendation can be made to the safety officer of the organization that management of the organization effect a change in the organizational culture that will encourage greater Anticipatory Awareness.

Collecting data repeatedly and periodically over time can also provide information on changes in the risk of human error over time, and possible strategies for reducing the risk. In particular, the levels of one or more types of awareness may change over time, indicating a progressively growing risk of human error. For example, collection of data over time may show that a particular subset of the organization has declining Anticipatory Awareness. One of the factors associated with Anticipatory Awareness is familiarity with co-workers and team members. A typical worker will have greater Anticipatory Awareness when working with familiar team members with whom he is comfortable. In this example, it may turn out to be the case that this same subset of the organization has seen substantial turnover of personnel in the recent past. Thus, it may be possible to trace the declining levels of Anticipatory Awareness to the lower levels of comfort and familiarity between workers. The safety officer can be notified of the risk, together with a recommendation that measures be to increase familiarity and comfort between the workers in the particular subset of the organization.

In summary, making a plurality of data collections over time (rather than just at a single point in time) has a number of advantages. First, there is greater precision and accuracy associated with data when there have been repeated and/or periodic collections. The repetition of the data collection provides greater confidence that the data collection can be validly generalized to the population of the institution being studied.

Second, organizations are very often in flux, though the degree and kind of changes that take place over time vary between organizations. Thus, a lack of one or more types of awareness within the organization may develop over time, often is response to one or more events taking place within the organization. One related benefit of a plurality of awareness data collections is that if one or more events occur which negatively affect one or more types of psychosocial awareness, then it may be possible to observe this problem developing before it becomes particularly acute, and thus to remedy the problem before it becomes more serious. A second benefit is that it is more likely that the developing awareness problem can be traced to a particular event or events, and this information can be used to develop safeguards for permanently preventing recurrence, even if the triggering event recurs. A third advantage is that, once a proposed solution to the awareness problem is implemented, continuing to collect data periodically and repeatedly over time allows the organization to see if the proposed solution worked. If it did, then the continued data collection should show an improvement in the awareness that was previously lacking.

Preferably, all error incident reports generated by the organization are provided to the database (reference numeral 12), so that data regarding human error in the error prediction time period can be accessed and used in association with data collected regarding psychosocial factors. Most preferably, they are also entered onto a website questionnaire form for uploading to the database 16. However, other modes of receiving and recording error incident reports may also be used. For example, if the organization uses paper incident reports, then the paper report can be received and the particulars recorded in the database 16. What is important is that the human error data is accessible for use in determining if one or more awareness factors predict human error in the organization 10.

It will be appreciated that all data, whether related to error incidents psychosocial constructs or any other subject, should preferably be communicated to the database 16 as promptly as possible. Therefore, it is preferred that the data be entered through a web-based form for immediate uploading to the database. However, in a case where paper forms are used to record data, it is preferable that the paper form be sent by a relatively fast method of transmission (e.g. fax) to a data entry point at which the data is entered into the database. Ultimately, any method of recording data can be used which results in adequately fast entry of the data into the database 16.

It will be appreciated that, in some industries, certain types of errors are automatically recorded. For example, modern passenger jets automatically record many types of pilot error, and this data is transmitted automatically to the airline. Preferably, the database 16 of the present invention automatically receives such automatically-recorded data in real time for use in data analysis.

Preferably, the error incident data and psychosocial construct data are analysed (reference numeral 18) in association with one another to identify elevated risk of human error, and the cause of such elevated risk. For example, if, over time, a certain psychosocial construct or combination of constructs correlates with particular human errors, the organization can be notified of the causal connection, and provided with recommendation on how to prevent future errors that would otherwise take place if no action is taken. The correlation between the psychosocial construct(s) and errors could take a number of forms. For example, the correlation could involve a change in both over time, or may involve lower levels of awareness in a specific section of the organization correlating with an unusually high number of certain types of errors in that specific section. By analysing error data and psychosocial construct data together (preferably by standard statistical methods), causal relationships between psychosocial constructs and errors are determined, risk is identified, errors are predicted, and recommendations can then be made on how to avoid predicted error.

Preferably, once initial psychosocial awareness factor data collection has begun, data, including both psychosocial awareness factor data and human error data, can be continuously received, and the database updated. Most preferably, this updating can take place at any time, 24 hours per day, 7 days per week, by many of automated processes. It will be appreciated that analysis of the data also preferably takes place, using computing resources associated with the database, 24 hours per day, 7 days per week. Constant updating and analysis of data is preferred because an indication can arise at any time in the data that error is likely. Furthermore, it is always possible that an error predicted by data analysis can occur very soon after the prediction is made. Thus, it is preferred that the database of the present invention be updated continuously, and new data analysed promptly.

Data in the database are used to determine whether a risk of human error is indicated, and which awareness factors are causing the risk. The presence and cause of a risk are preferably determined from analysing the psychosocial construct data, error data, and any other available data. Once a risk is predicted, and its cause identified, the Safety Officer of the organization is preferably notified (reference numeral 20) and informed of the type of error predicted by the data, and the cause as revealed by the psychosocial construct data. For example, suppose that an airport baggage handler has driven his vehicle into several baggage/cargo carts, damaging equipment, cargo and baggage. Meanwhile, data collected from baggage handlers shows that 37 percent of baggage handlers have begun reporting a lack of effective training in operational procedures, and 30 percent have begun saying that how they operate differs from standard operating procedure. The data in this case indicate that there will be additional human error resulting from lack of knowledge and understanding of operating procedures, a Functional Awareness problem.

Taking the same accident as an example, but with different data, the data may show that baggage handlers are well aware of operating procedures, and may be following those procedures, but that 43 percent of baggage handlers are not typically aware when they are in a fatigued state. In such a case, the Safety Officer would be notified that the data predict further error among baggage handlers caused by fatigue combined with a failure to be aware of the fatigue and take it into account.

This example demonstrates one of the main benefits of the present invention, namely, that the causes of errors are identified. As this example shows, a particular error could have one cause (e.g. fatigue) but if the cause is not identified, the organization may take action (e.g. more training) that will not be effective in preventing the error.

It will be appreciated that the prediction of error, and its cause, can be communicated to the organization through some channel other than through the Safety Officer. However, the Safety Officer is the preferred channel because of his dedication to safety issues and his channels of communication to those, such as the CEO, who can take action to prevent errors from occurring.

As an example of the operation of one embodiment of the present invention, consider the hypothetical case of A Co., a corporate entity operating a business distributing food supplies to restaurants, caterers, foodservice companies and other similar entities. A Co.'s operations include a number of tasks in which human error is a concern. For example, A Co. must order supplies, and receive and unload the ordered supplies. A Co.'s employees receive orders from customers, and the orders must be picked and put together for shipping. The orders are then loaded for shipping and shipped to A Co.'s customers.

The present invention is deployed within A Co. to survey safety threats and other types of human error across the A Co. organization, and to identify the relationship between this human error and the levels of the nine types of psychosocial awareness described above.

The inventory of questions (reproduced below) is put to people throughout the organization (both management and labour—850 employees in total) via online questionnaires. The entire inventory of questions is put to the totality of company's people each month, with each employee answering only a subset of the full inventory each month. The data collection takes place monthly over a period of three years.

After the first data collection, it is determined that the responses to the questions show no statistically significant lack of Anticipatory Awareness, Relational Awareness, Critical Awareness, Hierarchical Awareness, Task-empirical Awareness, Affective Awareness and Functional Awareness.

Meanwhile, it is immediately apparent that statistically significant problems with Environmental Awareness and Compensatory Awareness are present in the organization. The questions used to test for Environmental Awareness have a negative response between about 30 and about 60 percent of the time (the questions in the inventory are phrased so that a positive answer indicates no awareness problem, and a negative answer indicates an awareness problem). The questions used to test for Compensatory Awareness have a negative response between about 15 and about 40 percent of the time. Even before the periodic data collection continues, it is clear that there is a significant lack within A Co. of these two types of awareness. A Co. is therefore notified that these two types of awareness are lacking, likely causing safety problems and human error.

It is recommended to A Co., in respect of the lack of Environmental Awareness, that a program be developed and implemented to improve A Co.'s safety culture. In respect of the lack of compensatory awareness, it is recommended that training programs be developed and implemented which are designed specifically to educate employees under what operational conditions they must “compensate” their behaviour in order to protect safety. This would likely involve different programs for different operational aspects of the company's business.

Once these programs are developed and implemented, subsequent data collection shows a decline in the negative responses to questions relating to Environmental and Compensatory Awareness, and also a decline in the rate of human error incidents within the organization. That these corresponding declines follow upon implementation of the programs suggest a consequent increase in Environmental and Compensatory Awareness, and a consequent decline in human error incidents.

Subsequently, the monthly data collection begins to show a gradual decrease in relational awareness over several months. In particular, questions relating to management's perceived openness to safety challenges and other communications from junior employees begin to show progressively increasing negative responses. Thus, negative response to Relational Awareness questions went from statistical insignificance, to 11 percent one month, 19 percent the next month, and 31 percent the following month. Over the same period, but with a slight time lag, a gradual increase in human error incidents is observed. It is determined that these changes are statistically significant, and A Co. is notified that the human error incidents and the increase therein are caused by a Relational Awareness problem. This information allows a response to be developed to remedy the decrease in Relational Awareness and thus reverse the increase in human error incidents.

In the present example, it is found that, just prior to the increase in human error incidents and the decrease in Relational Awareness, several middle managers left A Co., and had been replaced by new managers which had a different approach to relations with more junior employees. Junior employees felt that management was no longer open to communication and challenge about safety concerns and employee roles. Therefore, such communication began to decrease, and human error incidents began to increase. Team building and training programs are implemented to improve this aspect of the relationship between the new managers and junior employees. Once this happens, continuing data collection shows decreasing human error incidents and increasing relational awareness.

It will be appreciated that this example demonstrates, inter alia, the benefits of a long error prediction time period. A long error prediction time period allows problems that develop over time to be perceived, analyzed and remedied, possibly before they become serious. Preferably, the error prediction time period will be indefinite (i.e. continuing without any intended end point), so that the use of this error prevention method will form part of the normal operation of the organization. However, it will be appreciated that the error prediction time period may be shorter. Preferably, the error prediction time period will be at least three years, though the invention comprehends shorter periods.

It will be appreciated that the steps of collecting and accessing data, and determining whether awareness factor data predicts human error, can be done in a variety of different ways. Most preferably, the data collection and accessing, as well as the analysis used to determine if human error is predicted, are fully automated. In this preferred embodiment, human error data are accessible from or contained in database 16, and collected awareness factor data are contained in database 16. Statistical processes are automatically performed to determine whether there is prediction of human error. In the preferred embodiment, the following statistical processes known to those skilled in the art are used to assess the changing over the error prediction time period of human error frequency, type and severity, and of the psychosocial awareness factors: Longitudinal analysis for prediction/estimation: survival and hazard analysis, lag-regression (logit/logistic vs. continuous, as appropriate to data type; linear vs. polynomial; multiple adaptive regression splines); and neural network modeling. For the assessment of human error frequency, type, and severity, and of which of the psychosocial constructs is causing the human errors over time, the following statistical methods known to those skilled in the art are preferably used: (1) Causal modeling: SEM (structural equation modeling), multiple linear and nonlinear regression, and path analysis; (2) Classification: Discriminant functions analysis, multinomial logit analysis, CHAID (Chi-squared Automatic Interaction Detector), CART (Classification and Regression Trees), latent class regression, and nominal regression; (3) Segmentation/Clustering: Hierarchical vs. nonhierarchical; agglomerative vs. divisive, segmentation to an outcome criterion vs. not; based on Euclidean distances vs. latent classes vs. decision tree (multi- or bi-nomial splitting)/automatic interaction detectors, Affinity grouping/association rules.

In the preferred embodiment, as can be seen in the appended inventory of questions, the questions are worded so that they are answered either by “yes” or “no.” A positive answer does not indicate an awareness problem, while a negative answers does. It will be appreciated that this method of phrasing the questions so that they are answered either “yes” or “no” makes data collection, handling and analysis much easier than it might otherwise be, since the answers are easily and automatically convertible to numerical representations for analysis.

It will be appreciated that different techniques may be used to collect and analyse data. Computers are much preferred, and automatic, preprogrammed processing by the computers is most preferred. However, the invention comprehends these steps being performed in other ways. What is important is that the collecting of awareness factor data, the accessing or human error data, and the determining of the awareness factors that predict human error are executed.

Embodiments of and modifications to the described invention that would be obvious to those skilled in the art are intended to be covered by the appended claims. Some variations have been discussed above, and others will be apparent. For example, though use of the internet is preferred for data collection is preferred, it is not required.

### APPENDIX

### Task-Empirical Awareness

### (Awareness of How to Assess for the “Normal” Operation of the Task at Hand)

1. I constantly evaluate my present working experience and environment as within normal operational limits for me
2. I make the immediate and necessary personal adjustments to keep myself within the normal operational range as defined by our operational procedures
3. I make the necessary interpersonal adjustments to keep myself within the normal operational range as defined by our operational procedures
4. I look for a consistent and predictable course of action in the operational theatre
5. I am easily distracted from the work I am doing
6. I assess my here and now experience in the workplace to against the backdrop of my own historical experiences
7. I quickly move beyond errors I make while in the operational theatre
8. While in the work process I consistently reference my experience in the here and now with past work experiences
9. It is typical for me to double check my interpretation of the situation by referencing other sources of information in the operational theatre
10. I typically use only one source of information to interpret operational status
11. While in the operational theatre the only discussion I have are process related
12. I know precisely those moments in the operational theatre that are more vulnerable to errors
13. I listen very closely to my body to inform me of operational changes
14. Changes in my body's experience (e.g., turbulence) are immediately confirmed by instrument confirmation and validation
15. The work I perform on a daily basis is in line with the operational procedures that are outlined for this function or workstation
16. I report to my supervisors when what I actually do on the job differs from what are prescribed for us in our standard operational procedures
17. Management quickly (7 to 14 days) modifies or changes our standard operational procedures when they have been informed of how our practice does not reflect what it is we actually do on the job

### Error Types and Frequency

1. Within the last month I made errors that were the result of not concentrating on the “correct” information at the moment (X2-HA)
2. Within the last month I made errors that were the result of being distracted from the object of my concentration

### Affective Awareness

(Awareness of How One's Emotions, Feelings, and/or Sensory Experience Informs Safe Operations)
1. I have no problem understanding what it is I am feeling
2. I listen to and understand what my emotions are telling me about the operational theatre
3. I allow my emotional experience to positively inform the decisions I make in the operational theatre
4. I will always listen to my feelings when I am engaged in a work activity or process
5. I feel I have become complacent in accepting our departments/teams poor compliance to operational procedures
6. I am that type of person who tends to worry too much about safety issues
7. I don't think about work or safety issues on my days off
8. There are people on my team/department that leave me feeling insecure or unimportant in the work process
9. I never feel intimidated by the behavior of those I work with
10. I will always express my feelings to my co-workers when it comes to protecting the safety of our clients/patients
11. I will always express my feelings to my supervisors when it comes to protecting the safety of our clients/patients
12. I work with co-workers and supervisors who treat the feelings of staff with respect and dignity
13. I trust that my emotions and feelings accurately read the environmental cues around me in the workplace
14. Excessive worry about safety is typical of my working environment
15. I have knowingly come to work and participated fully when I was sleep deprived
16. I have knowingly come to work and participated fully when I was physically ill
17. I will often “feel” an impending problem before it actually occurs
18. I tend to deny the negative effects of exhaustion on my performance
19. For over a month I have felt uneasy about our team's ability to come together and maximize our abilities
20. In the last 1 month I have become increasingly concerned about my coworkers compliance to operational procedures
21. In the last 2 months I have become increasingly concerned about my coworkers compliance to operational procedures
22. I am free to speak about my feelings and concerns in the workplace
23. I deploy the appropriate containment strategies to ensure that personal issues do not inter with my work
24. Emotions help me anticipate upcoming operational changes or challenges
25. I will removed myself from the operational theatre when I do not feel 100% well
26. I am able to read when my coworkers are feeling stress about aspects of our operational theatre
27. There is a specific “feel” and “attitude” I have when I am in the working role
28. My body informs me when operational safety is being threatened
29. There are specific instances in the operational theatre where I need to deny or suppress my feelings in order to stay focus on the safe operation of the task

### Error Types and Frequency

1. In the last 3 months there have been occasions where I should have listened to how I felt (e.g., uneasy) about a (safety) issue but did not
2. In the last 3 months I resisted speaking my true feelings/opinions about an operational issue, because I feared the consequence
3. In the last 3 months I resisted speaking my true feelings/opinions about an operational issue, because I thought no one would take me seriously
4. In the last 3 months I have become increasingly more concerned about how weak our safety policies are, with respect to the degree of risk we take on daily basis
5. In the last 3 months I have felt that intimidated by the peers/supervisors I am working with

### Compensatory Awareness

### (Awareness That Adjust or Compensates for Situational Variables)

1. I make the necessary behavioral adjustments in order to ensure that I protect the demands of the workplace
2. I establish the necessary boundaries around me in order to protect what is required of me to do my job safely
3. I believe my performance will not suffer should I continue to work at 70% of my potential
4. I anticipate and adjust my behavior accordingly in order to perform safely at work
5. I know where my intellectual and physical thresholds are for ensuring that I perform my job safely
6. When information is not forthcoming I will insist on gathering it immediately
7. I never have to compensate behaviorally for the short comings in leadership in our department
8. I will always let my team/co-workers know when I am not feeling well
9. I will often talk out loud or use some other type of memory game to ensure that I maintain strict compliance to our operational procedures
10. In order not to loose my place in the sequence of operational procedures I will develop a strategy to ensure I pick up from where I left off
11. I never have to compensate behaviorally for the short comings in operational procedures in our department
12. It is easy for me to adjust my behaviors in order to protect the operational safety limits of our department
13. Whenever I am unsure of my interpretation of the situation I immediately engage others in my team to correctly assess my own experience
14. It is natural for me to quickly adjust my operational behavior or objective when new and relevant information has been introduced
15. In the operational theatre I quickly adjust my decisions and actions to the skills and/or competency levels of those I am working with (in order to maintain operational compliance)
16. Should an essential piece of equipment become unserviceable I immediately reference other information or instruments to gather required operational information
17. Cross referencing my own experience and interpretation of an unfamiliar operational event with a co-worker or other instruments is typical for me
18. Our department is consistently up to date on all operational procedures and changes
19. Our existing operational procedures account for all eventualities in the operational theatre
20. I always know what to do in the operational theatre even when the unexpected occurs
21. I know exactly how to adjust my behavior for a team member who is not communicative
22. Whenever required I insist that our team set rules of engagement for policing one another's safety behavior in the operational theatre (ANT AW?)
23. Whenever required I will always insist on closed circuit communication loops from my peers and team members (closed circuit—meaning that essential information once communicated is acknowledged as received
24. Whenever I have been absent from work for greater than 4 weeks I will make the time to review our operational procedures
25. I always make sure to inquire about a new team members knowledge of our operational procedures
26. I will always insist on my questions or inquiries being addressed or answered during my shift
27. I do not go around my immediate supervisors in order to get the answers to my questions
28. I will challenge a team member who is operating independently or excludes other team members from aspects of the work process
29. I engage new team members by asking them if they need any assistance or clarification on operational protocols
30. I know exactly how to adjust my behavior for a team member who is not collaborative
31. I know exactly how to adjust my behavior for a team member who feels themselves more important than me
32. On a regular basis our team meets in a forum design to anticipate and problem solve for the unexpected event in the operational theatre

### Error Types and Frequency

1. I never have to cover up for the errors of coworkers
2. I never have to cover up for the errors in operational procedures
3. My most recent errors in the operational theatre were the result of not knowing how to adjust my actions to an unexpected event
4. In the last 3 months I was non compliant with our standard operational procedures because of the volume of work I must perform in an unrealistic period of time
5. In the last 3 months I was non compliant with our standard operational procedures because I did not have the appropriate support required to complete the work as required
6. In the last 3 months I was non compliant with our standard operational procedures because I did not accurately see and/or understand how the operational process has changed (e.g. I was thinking one thing and another was happening)
7. On more than one occasion in the last 3 months I knowingly worked outside of our operational parameters (e.g., cut corners) in order to get the job done
8. On more than one occasion in the last 3 months I knowingly worked outside of our operational parameters (e.g., cut corners) in order to get the job done

### Critical Awareness

### (Awareness Which Assesses and Evaluates the Present Task at Hand Against Their Own Experience Bank)

1. As the operational procedure unfolds I consistently evaluate here and now information with my own personal history for positioning and referencing
2. I position here and now events with what history tells me about the situation
3. I do not see any problem or threat in working while feeling exhausted and/or sleep deprived
4. The instruments I am working with provide appropriate information for me to make the correct decisions regarding operational safety
5. I know the critical points in the operational theatre wherein I consciously assess and evaluate the safety status of the present situation
6. The increase risks associated with working while sleep deprived or medicated are clear to me
7. As a team/department we rehearse our safety procedures on regularly scheduled intervals
8. Our safety and emergency procedures are comprehensive enough to anticipate all possible scenarios
9. My professional experience informs me about what operational pace is appropriate to ensure safe conduct while working
10. I will use my own experience bank to evaluate to appropriately assess a situation rather than listen to a co-workers opinion
11. I am confident in the safety and emergency procedures that are outlined for me in an emergency situation
12. While in the work process I will routinely reflect on the safety status of the operational theatre
13. I rely strongly on knowing under what circumstances I need to resist the sensory experience of my body in order to maintain safety (somatic errors)
14. I understand fully the deleterious effects of working while mentally impaired (Depression)
15. I fully understand the deleterious effects of working while medicated
16. I understand fully the deleterious effects of working while physically impaired
17. I make a conscious effort to utilize strategies such as “self talking” in order to maintain awareness of where I am in the checklist or procedures
18. I have worked while on a medication that could affect my cognitive functioning
19. It is more often the case that our professional experience guides our decision making process in critical phases of the operational process
20. During working conditions our team members collectively consult with one another to assess the status of operational safety

### Error Types and Frequency

1. The types of errors that are typically made in our work environment are due to a lack of critical review of the safety status of our operational theatre
2. The types of errors that are typically made in our work environment are due to individual team members not listening to critical opinion or challenge to existing operational conditions
3. In the last 3 months operational errors were made because of being exhausted and sleep deprived
4. The types of errors that are typically made in our work environment are due to a lack of operational de-briefings of our individual and team performance
5. In the last 3 months operational errors were made because I did not have enough experience in the setting to make the appropriate call
6. In the last 3 months operational errors were made because I listen to others rather than to what my own experience tells me
7. In the last 3 months I was non compliant with our standard operational procedures because I did not have the appropriate training on procedures

### Relational Awareness

### (Awareness for How the “Other” Influences Safe Operations)

1. When working in the operational theatre I feel I have the same authority as my peers and supervisors to voice my concerns over safety issues as they present themselves
2. Regardless of my rank in the operational theatre I voice my concerns over safety issues or non-compliance issues whenever I see them occurring
3. Each member of our team/department is seen as equally vital in protecting our operational goals
4. Each member of our team/department is seen as equally vital in protecting the safety of our operational processes
5. Ever member of our team/department recognizes that we can only maximize safety when we function as a cohesive unit
6. Whenever a relationship issue gets in the way of me performing my job according operational procedures I voice my concerns
7. I believe my concerns will be acted upon immediately in order to protect safety
8. Within our team or department each of us understands that we share the responsibility for maintaining safe operations
9. Our teams insists on debriefing exercises on a regular structured basis to review our performance in light of the operation procedures and expectations
10. Our leadership is committed to ensuring operational safety
11. Management has made approaching them on operational safety issues easy and simple
12. Management always welcomes a discussion regarding operational safety issues
13. Departments within our organization work to ensure that a seamless relationship exists between one another
14. It is my belief that an open and direct relationship between co-workers is essential to protect operational safety
15. Other teams/departments understand the degree to which we count on them to provide us with up to date information
16. Management welcomes a challenge to existing operational safety designs and/or procedures
17. It is easy for me to approach senior management on my team with concerns regarding their safety performance
18. Our supervisors/managers make it a priority to ensure team cohesion and cooperation
19. Our supervisors/managers welcome feedback on their capacity to protect operational safety
20. Team cohesion and collaboration is an essential part of our safety training
21. I know the type of interpersonal relationship that is required to protect operational safety
22. I have no fear of retaliation should I need to challenge my supervisor/manager regarding operational safety issues
23. My supervisor/manager welcomes opinions and criticisms regarding our existing operational procedures
24. My supervisor/manager welcomes opinions and criticisms regarding our team interaction
25. I welcome coworker feedback on my ability to be a constructive member of our team
26. Each member of my team takes responsibility for their own performance, good or bad
27. I willfully accept the criticism of others
28. Team cohesion and collaboration is a cornerstone of operational safety
29. I am able to recognize immediately when team cohesion begins to unravel
30. Most people in our team refrain from speaking openly and honestly about their experiences of working on teams
31. I trust the abilities and competencies of my coworkers
32. As a leader I structure non-negotiable meetings with my direct reports to dialogue about our safety conduct in the operational theatre
33. I am sensitive to how individual silos around team members can possibly influence operational safety
34. As a leader I create a working atmosphere that welcomes the expression of team members concerns regarding our performance
35. I recognize, as a leader, that an open door policy to express concerns and feelings around operational performance is not enough to ensure that team members will be forthcoming with their issues regarding safety
36. As a leader I have created a mechanism for the resolution of differences or conflicts within our department
37. As a leader I am sensitive to how different personalities can have a negative effect on maintaining operational compliance and safety

### Error Types and Frequency

1. The errors that our made in our working together as a team are typically related to not knowing the other persons job requirements
2. The errors that our made in our working together as a team are typically related to not communicating openly and honestly to one another
3. The errors that our made in our working together as a team are typically related to realizing that we were operating outside the safety envelope
4. In the last 3 months I worked with a colleague who I felt was not able to perform in accordance to operational requirements
5. In the last month I worked with a colleague who I felt was not able to perform in accordance to operational requirements
6. In the last 3 months communication errors, where one co-worker did not explain their intentions in detail, caused the team to make errors in judgment and actions
7. In the last 3 months I failed to communicate salient information to a co-worker/supervisor that could have potentially caused a safety problem
8. In the last month I failed to communicate salient information to a co-worker/supervisor that could have potentially caused a safety problem
9. In the last 3 months our safety integrity was compromised because our team/department did not communicate relevant information to other team members
10. In the last 3 months our safety integrity was compromised because our team/department did not communicate relevant information to other team members
11. In the last 3 months our safety integrity was compromised because our team/department did not communicate relevant information to other team members

### Functional Awareness

### (Awareness for the Meaning or Function of the Objects of Experience)

1. I am confident that our operational procedures are comprehensive enough in scope that we are protected from error
2. I understand precisely my co-workers role in protecting operational safety
3. It is very rare that I feel rushed or unprepared to work when I get called into work when I am on reserve or on call
4. I rely strongly on my critical sources of operational information to give me a sense of security regarding the work I am about to perform (e.g., mailbox, emails, handoffs from co-workers)
5. I usually begin the day before work to mentally and physically prepare myself for work
6. I will typically visualize the work environment and operational theatre prior to going into work
7. I will not ignore the performance shortcomings of my peers and co-workers
8. My attitude towards work is different when I am on reserve or on call than when I work scheduled shift
9. I will often use the interaction of my peers on a daily basis to assess what type of “safe operating” day we will have (compliance day we will have)
10. When I do not understand the function or meaning of a component of the operational procedure I will immediate seek clarification of its significant and place in the process
11. The equipment I use in my work provides me with more than enough information to ensure that I have a rich understanding of all the salient variables involved in the operational theatre
12. The equipment I use is reliable, in that I never worry about its ability to assist me in operating safely
13. I understand each and every operational procedure that I am asked to follow
14. Every step and procedure in our operational procedure manual makes clear sense to me
15. When I am distracted during my work, which may include the operational theatre, I can accurately re-engage myself in the work process
16. At any given moment in the operational theatre I know immediately what instrument or scan is required to protect operational safety
17. The operational procedures we follow to ensure safety are more than sufficient to ensure safety
18. I feel I have appropriate training in operational procedures
19. I feel I bring a rich amount of safety insight and training to this work environment
20. I can understand the significance of each step in our operational procedures
21. I know under which specific operational conditions the importance or value of operational variables change
22. I feel I have appropriate training in safety procedures
23. I am hypersensitive to “strange and unusual” events or occurrences in our operational theatre

### Error Types and Frequency

1. The types of errors I have made in the last 3 months have been the result of not knowing the significance or function of a specific operational procedure (e.g., why I would don a mask during a depressurization)
2. When I make a mistake in the workplace or operational theatre it is the result of not understanding the correct operational procedure(s)
3. The types of errors I make are related to not having the appropriate knowledge and training on operational procedures
4. The types of errors I make are related to not seeing how unfolding events would negatively impact on operational safety

### Environmental Awareness

### (Awareness of How Variables in the Physical and Cultural Environment Impact Safety)

1. I am consistently assessing and evaluating the operational theatre for hazards or anything out of the ordinary
2. I am acutely aware of the organization's attitude towards protecting safety
3. Our organization unconditionally supports the need for ensuring safe operational conditions in the workplace
4. Our organization has a team dedicated to working through possible risk management situations and deriving solutions to them
5. Organizational and cultural safety are a priority for our organization
6. Our organization ensures that we have the tools and training to ensure that we are competent at maintaining operational safety
7. Our organization is compliant with operational safety procedures
8. Our organization fully supports us in operational safety training programs
9. Our management team are ever mindful of the human and systemic factors that can endanger safe operations within our workplace
10. Our management team very rarely acts punitively to someone who willfully acknowledges the operational errors they have made will working
11. Our organization has in place a mechanism that rapidly resolves the conflict between allocating monies to operational needs versus the allocation of monies for safety
12. Operational errors are reviewed and discussed regularly by senior personnel of our organization
13. Safety and performance debriefing exercises are standard operational procedures in our organization
14. Our organization has in place a useful and intelligent feedback system to report on system, team, and/or individual errors
15. Our supervisors/managers will acknowledge individual efforts to draw attention to safety issues
16. I know exactly who to go to for immediate information regarding operational safety
17. Our organization sets paid time aside for employees to review and refresh themselves on sops
18. My ideas about improving operational are always listened to by management
19. Our supervisors/managers will reward individual efforts to draw attention to safety issues
20. I feel I am fully informed about all safety procedures in our department
21. I feel I am fully informed and educated about all standard operational procedures of our department
22. Whenever systems or operations shortcomings have been identified our organization makes the necessary changes to standard operational procedures immediately
23. Revised changes to our sops are effectively communicated throughout the organization
24. Management is solely responsible to disseminate any/all changes to our sops
25. I feel we are sitting on an operational time bomb which is ready to explode when it comes to the administration recognizing how vulnerable we are to operational errors being made
26. The administration of our facility will always deal with professional who are non-compliant to operational procedures
27. The will to ensure the safety of our staff within our system and those we provide service to is part of this leadership's mandate
28. There is a dedicate individual within our organization that ensures all new personnel are fully trained in our operational protocols around safety
29. Our organization places a high priority on the individual's safety history prior to hiring
30. Our organization is acts immediately to change weaknesses in our operational protocols
31. Our safety system is fluid rather than rigid
32. The culture of organization is one that makes operational safety a priority
33. We are encouraged by management to participate in ongoing safety training programs

### Error Types and Frequency

1. In the last 3 months the type of errors that I make are the result of not having received relevant operational information prior to engaging work
2. In the last 3 months the type of errors that are made in our operational theatre extend from a lack of value attached to safety in our organization
3. In the last 3 months the types of errors I made were the result poor definition and/or detail in our sops
4. In the last 3 months I have witnessed errors go unnoticed and unreported

### Hierarchical Awareness

### (Awareness of an Objects Place, Order, or Hierarchy or Importance in the Sequence)

1. I know the correct sequence of operational procedures in the operational theatre
2. I know the correct sequence of operational procedures in the operational theatre, and will at times change the operational order
3. Our organization understands how systemic problems contribute errors rates in the system
4. I understand the significance of each operational guideline and requirement in our operational procedures
5. I am concerned that our operational procedures are not detailed enough to account for all the possible scenarios in the operational theatre
6. During critical phases within the operational theatre I insist on absolute compliance to operational protocols
7. I will resist any attempt by a team member or coworker to adjust or modify the order of operational procedures
8. In our department we are always disciplined at ensuring we follow every step, in the correct order, in the ops procedures
9. I understand when certain operational variables take priority over others in the operational theatre
10. During the operational procedure I know exactly when to de-focus (shift) my attention from one object or person to the next most significant

### Error Types and Frequency

1. Within the last month the types of errors I made were the result of not concentrating on the “correct” information at the moment
2. Often important steps in our operational procedures are overlooked by our team or by individuals
3. Often important steps in our operational procedures are knowingly overlooked by our team or by individuals
4. Over time our attention to operational safety has declined
5. Operational safety is not longer a priority for our department and/or team
6. Within the last 3 months I mistakenly changed the order of the prescribed operational procedures
7. Within the last 3 months I made one or more errors as a result of forgetting to follow the correct operational procedure
8. Within the last 3 months I made one or more errors as a result of the routineness of the procedure
9. Within the last 3 months I made one or more errors as a result of forgetting to follow the correct operational procedure

1. A method of preventing human error in an organization, the method comprising:
making a plurality of collections of psychosocial awareness factor data over an error prediction time period from individuals performing tasks within the organization;
accessing human error data relating to the error prediction time period on human error incidents within the organization;
using the human error data and psychosocial awareness factor data to determine whether the level of one or more awareness factors predicts human error;
if said one or more awareness factors predicts human error, notifying the organization of the nature of the human error predicted, and of the one or more awareness factors that are the cause of the human error.

2. The method as claimed in claim 1, wherein the making step comprises asking members of the organization questions at least four times per year.

3. The method as claimed in claim 2, wherein the asking step comprises asking questions on an online questionnaire.

4. The method as claimed in claim 3, wherein the making comprises asking an inventory of questions, wherein a subset of the inventory is asked at least four times per year, and wherein the asking of subsets of questions continues until each individual has answered all of the questions in the inventory.

5. The method as claimed in claim 1, wherein the making step and collection step can be performed on any day, at any time of day.

6. The method as claimed in claim 1, wherein the determining step comprises finding temporal correlations between errors and psychosocial awareness factors.

7. The method as claimed in claim 1, wherein the determining step comprises finding unsafely low levels of one or more types of awareness within the psychosocial awareness factor data.

8. The method as claimed in claim 1, wherein the determining step comprises finding a correlation between a portion of the organization with which one or more errors have occurred and levels of awareness within that portion of the organization.

9. The method as claimed in claim 2, wherein the questions are phrased so that a negative response indicates a lack of awareness.

10. The method as claimed in claim 1, wherein the error prediction time period is at least three years.

11. The method as claimed in claim 1, wherein data collected in the making step and in the collecting step are stored in a database configured to facilitate automatic analysis.
